(19) United States
(12) Patent Application Publication
(10) Pub. No.: US 2006/0190402 A1
(43) Pub. Date: Aug. 24, 2006

(54) System and method of controlling access to content

(76) Inventors: David Patron, Cedar Park, TX (US); L. Peter Lowrie, Austin, TX (US); Sreenivasa Gorti, Austin, TX (US); Donald Garofalo, Austin, TX (US)

Correspondence Address: TOLER SCHAFFER, LLP, 5000 PLAZA ON THE LAKES, SUITE 265, AUSTIN, TX, 78746, US

(21) Appl. No.: 11/064,775

(22) Filed: Feb. 24, 2005

(51) Int. Cl. G06F 17/60

(52) U.S. Cl. 705/51

(57) ABSTRACT

A method of providing access to content is described and includes receiving a selection of content. The method includes determining whether access is allowed to the content. A PIN entry screen is presented at a television. Further, a request permission soft button is presented at the television. When a correct PIN is received, access is provided to the content. The method also includes receiving a request for permission to access the content. Particularly, the request for permission is received after the request permission soft button is selected. Also, the method includes determining whether a guardian is available to receive the request for permission. The request can be transmitted to an end user terminal of the guardian after determining that the guardian is available. The method can also include indicating that access to the content is denied after determining that the guardian is not available.

### FIELD OF THE DISCLOSURE

The present disclosure relates to set top boxes and to controlling access to video content.

### BACKGROUND

Cable television providers and satellite television providers can restrict access to television content based on parental controls. For example, a parent can program a set top box to not allow content from particular channels. Also, the set top box can be programmed to prevent access to content based on the rating of the content. In either case, if a user wants to watch restricted content he or she can be challenged by the set top box to provide a personal identification number (PIN) to unlock the content. If a correct PIN is entered, the video service allows the user to watch the content. If an incorrect PIN is received, access to the content is denied. Current PIN-based systems are based on simple policy mechanisms and do not support more flexible rule-based policy mechanisms and dynamic decision-making associated with such mechanisms.

Accordingly, there is a need for an improved system and method of controlling access to television content.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of a content distribution system;

FIG. 2 is a representation of a graphical user interface for accessing protected content; and

FIG. 3 is a flow chart to illustrate a method of providing access to protected content.

### DETAILED DESCRIPTION OF THE DRAWINGS

A method of providing access to content is described and includes receiving a selection of content. Then, the method includes determining whether access is allowed to the content. A personal identification number (PIN) entry screen is presented at a television. Further, a request permission soft button is presented at the television.

In a particular embodiment, the method further includes indicating that access to the content is denied. When a correct PIN is received, access is provided to the content. The method also includes receiving a request for permission to access the content. Particularly, the request for permission is received after the request permission soft button is selected. Further, in a particular embodiment, the method includes determining whether a guardian is available to receive the request for permission. The request can be transmitted to an end user terminal of the guardian after determining that the guardian is available. In a particular embodiment, the method includes indicating that access to the content is denied after determining that the guardian is not available.

Further, in another particular embodiment, the method can include determining whether a response is received from the guardian within a predetermined time period and indicating that access to the content is denied after determining that the response from the guardian is not received within the predetermined time period. Additionally, the method can include determining whether the guardian has granted permission to access the content after determining that the response from the guardian is received. It can be indicated that access to the content is denied after determining that the guardian has not granted permission to access the content. Alternatively, access can be provided to the content after determining that the guardian has granted permission to access the content.

In another embodiment, a set top box is described and includes a processor and a computer readable medium that is accessible to the processor. A computer program is embedded within the computer readable medium. The computer program can include instructions to present a graphical user interface that has a PIN entry field and a request permission to access content soft button at a display device coupled to the set top box when a user selects restricted content.

In yet another embodiment, a server is described and includes a processor and a computer readable medium that is accessible to the processor. A computer program is embedded within the computer readable medium and includes instructions to request permission from an end user terminal of a guardian to provide access to restricted content at a set top box coupled to the server via a data network

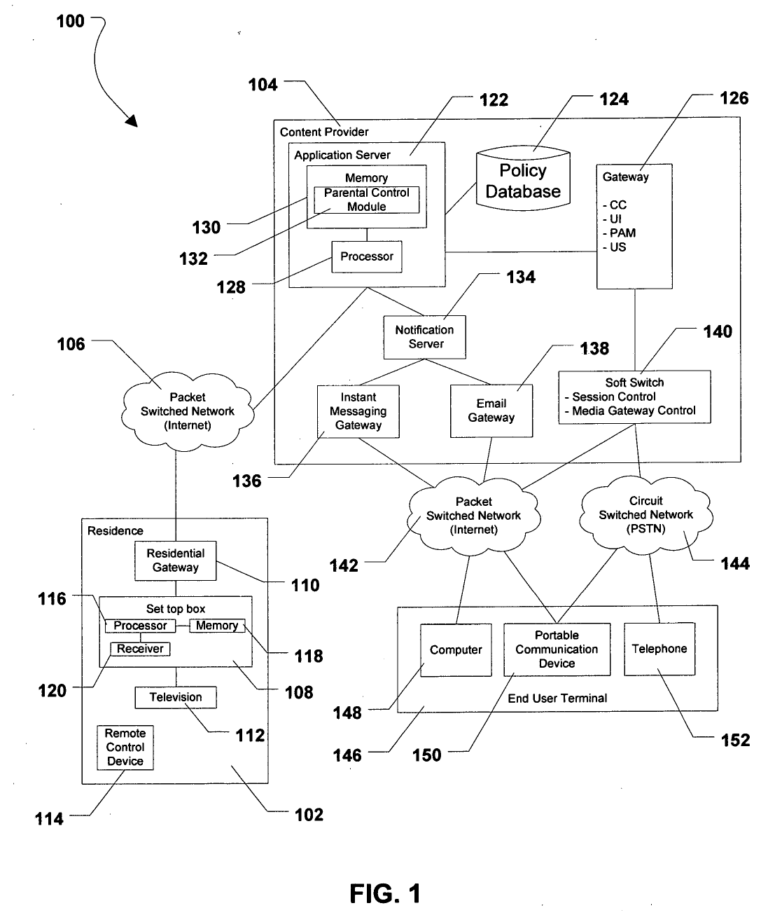

Referring initially to FIG. 1, a system of providing access to television content is shown and is generally designated 100. As shown the system 100, includes a customer residence 102 that is connected to a content provider 104 via a first packet switched network 106. In a particular embodiment, the first packet switched network 106 is a private network that provides connectivity to the Internet. As shown in FIG. 1, the customer residence 102 includes a set top box 108 that is coupled to the first packet switched network 106 via a residential gateway 110. A television 112 is also coupled to the set top box 108. Further, a remote control device 114 is provided and can be used to input one or more controls to the set top box 108 or to the television 112. FIG. 1 also indicates that the set top box 108 can include a processor 116. A memory 118 is coupled to the processor 116. Also, a receiver 120, e.g., an infrared (IR) receiver or a radio frequency (RF) receiver, can be coupled to the processor 116 within the set top box 108. The receiver 120 can receive one or more control signals from the remote control device 114.

In a particular embodiment, the set top box 108 includes a return data path back to the content provider. For example, the set top box 108 can be an IP-TV set top box that has a return data path to the content provider. Alternatively, the set top box 108 can be a combination satellite-IP set top box that has a return data path to the content provider.

As further depicted in FIG. 1, the content provider 104 includes an application server 122 that is coupled to the first switched network 106. A policy database 124 is coupled to the application server 122. In a particular embodiment, the policy database 124 stores parental control rules that can be input by a parent or guardian. For example, the parental control rules can include which channels are and are not restricted, time of day when content can or cannot be viewed, a threshold rating to prevent particular content items from being viewed, and monthly allowances to purchase video on demand or other premium content.

FIG. 1 further indicates that a gateway 126 can be coupled to the application server 122. In a particular embodiment, the gateway 126 is a gateway and the application server 122 communicates with the gateway using parlay. However, the application server 122 can communicate with the gateway 126 using other protocols, e.g., session initiation protocol (SIP) or session initiation protocol for instant messaging and presence leveraging extensions (SIMPLE). As shown in FIG. 1, the application server 122 includes a processor 128 and a memory 130 coupled to the processor 128. Further, a parental control module 132 is embedded within the memory 130. In a particular embodiment, the parental control module 132 can be executed by the processor 128. FIG. 1 shows that a notification server 134 can be coupled to the application server 122. Moreover, an instant messaging (IM) gateway 136 and an email gateway 138 are coupled to the notification server 134. Also, a soft switch 140 is coupled to the gateway 126. In a particular embodiment, the application server 122 can communicate with the soft switch 140 via the gateway 126. However, in an alternative embodiment, the application may communicate directly with the soft switch 140, without the gateway 126, e.g., using SIP. As indicated in FIG. 1, the IM gateway 136 and the email gateway 138 are coupled to a second packet switched network 142, e.g., the Internet. The soft switch 140 is coupled to the second packet switched network 142 and to a circuit switched network 144, such as the public switched telephone network.

In a particular embodiment, the notification server 134 can determine if a guardian is available to receive a permission request and route the permission request to an appropriate device for the guardian, e.g., an IM enabled device, a short message service (SMS) enabled telephone, a two-way pager, or an analog telephone. In particular, the IM gateway 136 allows the parental control module 132 within the application server 122 to query for the guardian's presence in an IM network and facilitates interfacing with the IM network. Additionally, the gateway 126 can allow the parental control module 132 to access subscriber presence information on a telephone network and allows for interfacing to the circuit switched network 144 and cellular messaging network via the soft switch 140.

As illustrated in FIG. 1, the second packet switched network 142 and the circuit switched network 144 provide connectivity to an end user terminal 146. For example, the second packet switched network 142 provides connectivity to a computer 148 and a portable communication device 150, such as an instant messaging device. Also, the circuit switched network 144 provides connectivity to the portable communication device 150 and to an analog telephone 152. It can be appreciated that as other methods of communication are developed, those methods can also be used to communicate with a guardian.

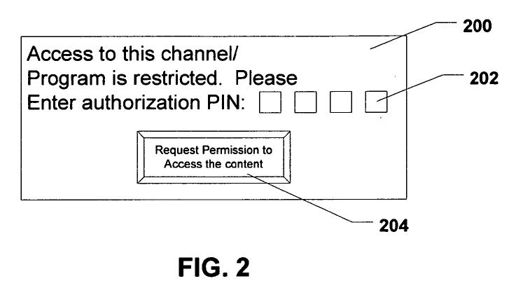

Referring to FIG. 2, an exemplary, non-limiting embodiment of a PIN entry screen is shown and is generally designated 200. The PIN entry screen 200 can be presented to a user when the user attempts to view a channel or a program that is restricted, e.g., by a parental control. As shown, the PIN entry screen 200 includes a PIN entry field 202 in which multiple digits of a PIN can be entered. Further, the PIN entry screen 200 includes a request permission to access the content soft button 204. When the PIN entry screen 200 is presented to a user, the user can request permission to access restricted content by selecting the request permission to access the content soft button 204 instead of entering a PIN. The set top box can work in conjunction with a application server at the content provider in order to determine whether a guardian is available to receive a request for permission and whether the guardian wants to provide permission to access the restricted content.

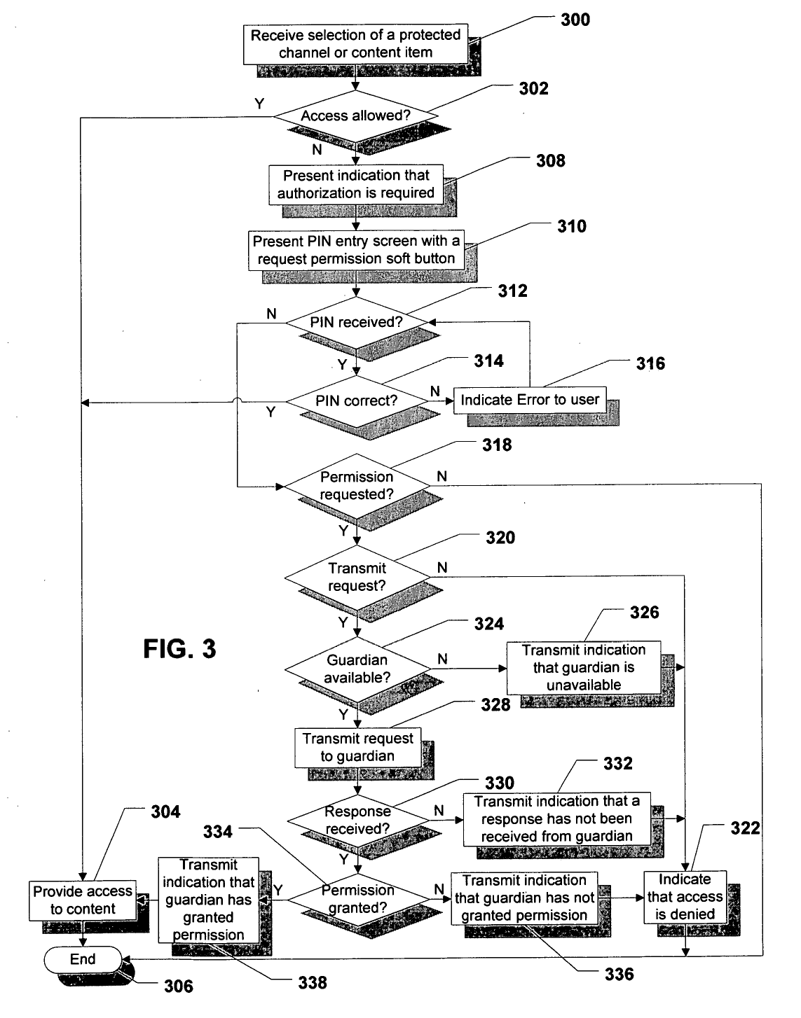

Referring to FIG. 3, a method of providing access to television content is shown and commences at block 300. At block 300, the set top box receives a selection of a protected channel or content item. For example, the set top box can receive a selection from a remote control device. Moving to decision step 302, the set top box determines whether access to the content is allowed. If access is allowed, the method moves to block 304 and the set top box provides access to the content. The method then ends at state 306.

In a particular embodiment, the decision made at decision step 302 is based on policies that are local to the set top box. Further, the policies can be stored at a policy database that is coupled to an application server that communicates with the set top box. The policies can set by a guardian via a web interface with the application server. Thereafter, the policies can be transmitted from the application server to the set top box. The policies can be transmitted at regular intervals or when changes are made to the policies. In an alternative embodiment, the policies are stored at the database coupled to the application server and the decision of whether access to the content is allowed can be made at the application server. The result of the decision can be transmitted to the set top box.

At decision step 302, if access is not allowed, the method continues to block 308 and the set top box presents an indication that authorization is required to access the content. Thereafter, at block 310, the set top box presents a personal identification number (PIN) entry screen with a request permission soft button. At decision step 312, the set top box determines whether a PIN is received from a user. If a PIN is received, the method moves to decision step 314, and the set top box determines whether the PIN is correct. If the PIN is correct, the method proceeds to block 304 and access is provided to the content. The method then ends at state 306. If an incorrect PIN is received at decision step 314, the method moves to block 316 and the set top box indicates an error to the user. The logic then returns to decision step 312 and continues as described above.

At decision step 312, if a PIN is not received, the method moves to decision step 318 and the set top box determines whether the user has requested permission to access the television content, e.g., by selecting a request permission soft button using the remote control device. If permission is not requested, the method ends at state 306. On the other hand, at decision step 318, if permission is requested, the method moves to block 320 and the set top box determines whether to transmit the permission request. For example, a controlling user, such as a parent, may have indicated that access is denied and that no permission may be granted to a subordinate user. Or, the parent may have indicated that he or she will not accept any requests to authorize access to the restricted content. If the set top box determines not to transmit the request, the method proceeds to block 322 and the set top box indicates that access to the content is denied. The method then ends at state 306.

Returning to decision step 320, if the set top box determines to transmit the request to the application server, the method continues to decision step 324. At decision step 324, the application server, e.g., a parental control module within the application server, determines whether the parent or guardian is available. In a particular embodiment, the application server may determine whether the parent is available through a relatively simple subscribe/notify request to a network-based presence server, or through directly querying the presence server using an application program interface (API), such as a parlay user status service capability server (SCS).

If the guardian is not available, the method proceeds to block 326 and the application server transmits an indication to the set top box that the guardian is not available. Then, the method moves to block 322 and the set top box indicates that access to the content is denied. The method then ends at state 306. Returning to decision step 324, if the guardian is available, the application server transmits the request for permission to the guardian via the end user terminal at block 328. For example, if the parent is logged on to an instant messaging service and the parent is active, i.e., the parent is not in a do not disturb mode, the application server can transmit an instant message to the parent with a request for permission to access the restricted content.

Further, the application server can transmit a text message to a short message system device or an email to a two-way pager. The parent can respond to any of these messages and grant or deny access to the restricted content. Additionally, the application server can initiate a voice call to the subscriber with a recorded message requesting permission to access the restricted content. An interactive voice response system can be used to authenticate the parent, e.g., by requesting a PIN. Alternatively, the parent can be prompted to enter a “1” to grant permission or a “2” to deny permission.

Moving to decision step 330, the application server determines whether a response has been received within a predetermined time period. If a response is not received, the method proceeds to block 332 and the application server transmits an indication to the set top box that the guardian is not responding. Thereafter, the method moves to block 322 and the set top box indicates that access to the content is denied. Then, the method ends at state 306.

Returning to decision step 330, if a response is received, the method moves to decision step 334 and the gateway server determines whether the guardian has granted permission to access the content. If the guardian has not granted permission, the application server transmits an indication to the set top box that the guardian has not granted permission to the content, at block 336. Then, at block 322, the set top box indicates that access to the content is denied and the method ends at state 306. If the guardian has granted permission, at decision step 334, the method moves to block 338. At block 338, the application server transmits an indication to the set top box that the guardian has granted permission to the content. Thereafter, at block 304, the set top box provides access to the content. The method then ends at state 306.

In an alternative embodiment, after a user selects a protected channel or content item and the user is presented with a PIN entry screen and the request permission soft button, the user can leave the channel on the PIN screen, in lieu of selecting the request permission to access the content soft button. Thereafter, when the guardian logs on to a web sit associated with the service provider, the guardian can be presented with a request to unlock the protected channel or content. The guardian can then decide whether or not to unlock the protected channel or content.

With the configuration of structure described above, the system and method of providing access to television content provides a content control system that allows parents or guardians to be away from home and still control what their children are watching. Further, the system and method allows parents and guardians to determine policies to control television viewing and gaming habits for their children. The policies can be dependent on the type of content, i.e., on the rating of the content; the channel line-up; and the total amount of television watched per day, week, or month. The system and method can also be used to enforce disciplinary actions taken by a parent in which he or she has instituted a television “blackout” for a predetermined time period. Further, the system and method can be used to enforce a monthly allowance for purchasing premium content, e.g., movies on demand, pay-per-view, video games, etc. Also, the system and method can be used to block certain channels or block recording by a digital video recorder within the set top box access during certain time periods.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing access to content, the method comprising:
receiving a selection of content;
determining whether access is allowed to the content;
presenting a personal identification number (PIN) entry screen at a television; and
presenting a request permission soft button at the television.

2. The method of claim 1, further comprising indicating that access to the content is denied.

3. The method of claim 1, further comprising providing access to the content after a correct PIN is received.

4. The method of claim 1, further comprising receiving a request for permission to access the content.

5. The method of claim 4, further comprising granting permission to access the content.

6. The method of claim 4, wherein the request for permission is received after the request permission soft button is selected.

7. The method of claim 4, further comprising determining whether a guardian is available to receive the request for permission.

8. The method of claim 7, further comprising transmitting the request to an end user terminal of the guardian after determining that the guardian is available.

9. The method of claim 7, further comprising indicating that access to the content is denied after determining that the guardian is not available.

10. The method of claim 8, further comprising determining whether a response is received from the guardian within a predetermined time period.

11. The method of claim 10, further comprising indicating that access to the content is denied after determining that the response from the guardian is not received within the predetermined time period.

12. The method of claim 10, further comprising determining whether the guardian has granted permission to access the content after determining that the response from the guardian is received.

13. The method of claim 12, further comprising indicating that access to the content is denied after determining that the guardian has not granted permission to access the content.

14. The method of claim 12, further comprising providing access to the content after determining that the guardian has granted permission to access the content.

15. A set top box, comprising:
a processor;
a computer readable medium accessible to the processor; and
a computer program embedded within the computer readable medium, the computer program comprising:
instructions to present a graphical user interface having a personal identification number (PIN) entry field and a request permission to access content soft button at a display device coupled to the set top box when a user selects restricted content.

16. The set top box of claim 15, wherein the computer program further comprises instructions to determine when the request permission to access content soft button is selected.

17. The set top box of claim 16, wherein the computer program further comprises instructions to indicate that access to the restricted content is denied after determining that permission cannot be granted to access the restricted content.

18. The set top box of claim 16, wherein the computer program further comprises instructions to transmit the request for permission to a application server.

19. The set top box of claim 18, wherein the computer program further comprises instructions to indicate that access to the restricted content is denied after receiving an indication that the guardian is unavailable to grant permission.

20. The set top box of claim 18, wherein the computer program further comprises instructions to indicate that access to the restricted content is denied after receiving an indication that the guardian has not granted permission to access the restricted content.

21. The set top box of claim 18, wherein the computer program further comprises instructions to indicate that access to the restricted content is granted after receiving an indication that the guardian has granted permission to access the restricted content.

22. A server, comprising:
a processor;
a computer readable medium accessible to the processor; and
a computer program embedded within the computer readable medium, the computer program comprising instructions to request permission from an end user terminal of a guardian to provide access to restricted content at a set top box coupled to the server via a data network.

23. The server of claim 22, wherein the computer program further comprises instructions to determine whether the guardian is available to receive a request for permission after the request for permission is received from the set top box.

24. The server of claim 22, wherein the computer program further comprises instructions to transmit an indication to the set top box that the guardian is unavailable to receive the request for permission.

25. The server of claim 24, wherein the computer program further comprises instructions to transmit the request for permission to the guardian.

26. The server of claim 25, wherein the computer program further comprises instructions to determine whether the guardian has granted permission to access the restricted content after determining.

27. The server of claim 26, wherein the computer program further comprises instructions to transmit an indication that the guardian has not granted permission to access to the content to the set top box after determining that the guardian has not granted permission to access the restricted content.
